(19) United States
(12) Patent Application Publication
(10) Pub. No.: US 2008/0270271 A1
(43) Pub. Date: Oct. 30, 2008

(54) Method and Computer-Readable Medium for Managing Order Entry

(75) Inventors: Ted Kachel, Purchase, NY (US); John Orem, Oklahoma City, OK (US); Ted Growe, Piedmont, OK (US); Blaine Trimmell, Edmond, OK (US); Deborah Miller, Moore, OK (US); Brian Fredrickson, Oklahoma City, OK (US)

Correspondence Address: CROWELL & MORING LLP;INTELLECTUAL PROPERTY GROUP, P.O. BOX 14300, WASHINGTON, DC, 20044-4300, US

(73) Assignee: Axiom Automotive Technologies, Inc., Pittsburgh, PA (US)

(21) Appl. No.: 11/740,347

(22) Filed: Apr. 26, 2007

(51) Int. Cl. G06Q 30/00

(52) U.S. Cl. 705/30

(57) ABSTRACT

A method and computer-readable medium for managing order entry by a user via remote connection to an account database system of a service provider are provided. According to the method, order information is received from the user via the remote connection for an account of the user. Payment information is outputted to an external payment service for authorization of payment, and, if the authorization is successful, order information is received and written to a custom database of the service provider. A transaction record is then written to an account transactions file of the service provider, thereby triggering execution of an accounting program for posting the order information to the user's account and to records of the service provider. The updated order information may then be outputted to the user.

### BACKGROUND OF THE INVENTION

The present invention relates to a method and computer-readable medium for managing order entry. More specifically, the present invention relates to a method and computer-readable medium for allowing a plurality of users to simultaneously manage order entry remotely, e.g., via the Internet, by triggering a database function.

Currently, users may either call a company's customer service representative and provide order information over the telephone or send orders via mail to order items on their accounts. The user tells a customer service personnel which items are to be ordered and how many of each item. The customer service personnel then processes the order and enters order information into the company's accounting system. This is a labor intensive process, requiring a significant amount of time and numbers of employees for the company to process the orders. Alternatively, users may order items via the Internet.

### SUMMARY OF THE INVENTION

The present invention allows a plurality of authorized users to simultaneously access a company's order entry database in a multi-threaded environment through an Internet web page. Each user is able to access the system as if he or she were the only user on the system. Accordingly, none of the users impacts any of the other users. Methods according to the invention provide a “self-service” ordering process for users.

According to the present invention, the ordering transaction is processed without intervention by the company, and the order is recorded in the order detail records of the company. The Internet web page may be used to trigger execution of an accounting software program to create an order for shipment.

Other objects, advantages, and novel features of the present invention will become apparent from the following detailed description of the invention when considered in conjunction with the accompanying drawings.

### BRIEF DESCRIPTION OF THE DRAWINGS

FIG. 1 illustrates an exemplary embodiment of a system for managing order entry in accordance with the present invention; and

FIGS. 2A and 2B illustrate an exemplary embodiment of a method for managing order entry in accordance with the present invention.

### DETAILED DESCRIPTION OF THE EXEMPLARY EMBODIMENTS

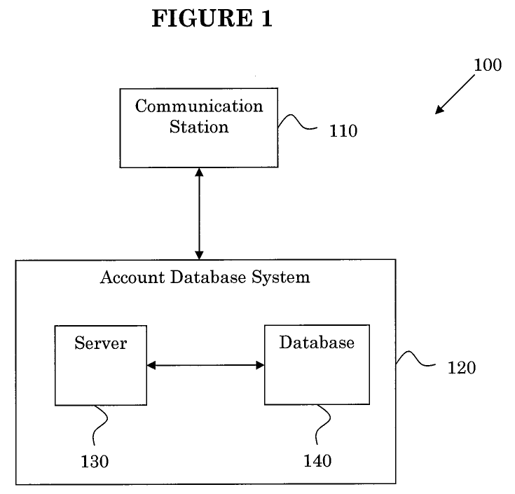

FIG. 1 illustrates an exemplary embodiment of a system for managing order entry in accordance with the present invention. As illustrated in FIG. 1, the system 100 includes a communication station 110, which may be a computer, PDA, etc., which provides a user interface. The communication station 110 may be connected to an account database system 120 of a company (service provider) via a remote connection, which may be an Internet connection, for example. The account database system 120 may include a server 130 and one or more databases 140. The server may be an IBM Corporation i-Series server, for example. A database program, such as DB2, may be used to access the data contained in the databases.

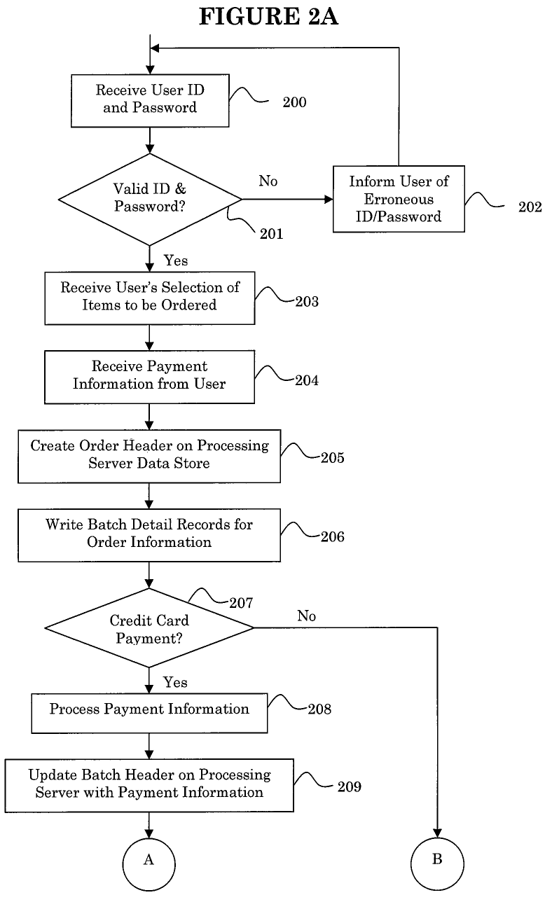

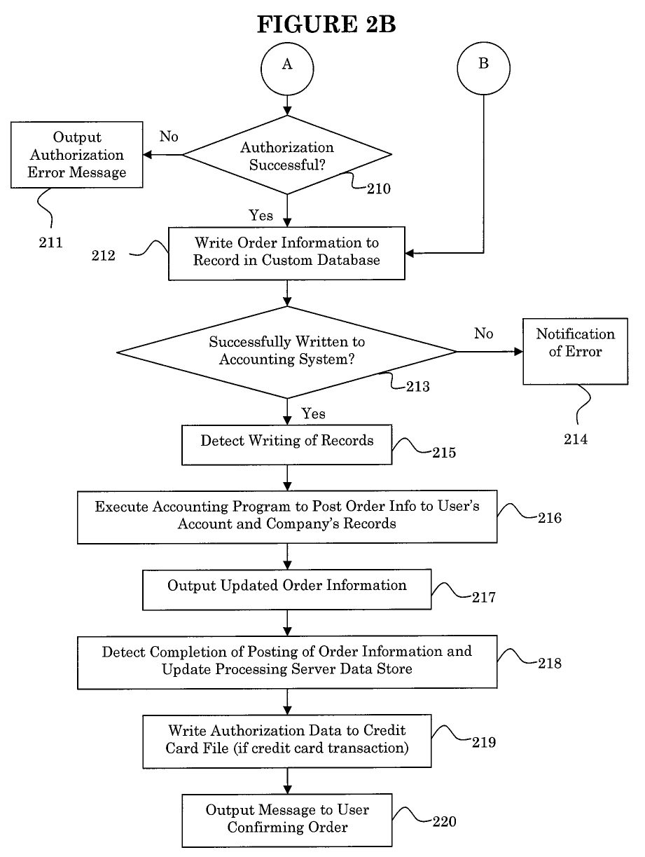

FIGS. 2A and 2B illustrate an exemplary embodiment of a method for managing order entry in accordance with the present invention. A user may access the account database system 120 over the Internet via the communication station 110. After opening an order entry web page of the service provider, the user may gain access to the account database system 120 by entering a user ID and password via the user interface of the communication station 110. The user ID and password are received in step 200. In step 201, a check is performed to determine whether the ID and password information are valid. If they are not valid, a message is sent to the user to inform him or her of the erroneous ID and/or password in step 202, at which point the user may again try to login to the system by re-entering the ID and password. If the ID and password are valid, the user is logged into the account database system 120.

Although the method is described for one user, an advantage of the present invention is that a plurality of users may simultaneously enter orders into the account database system. Thus, the system can simultaneously process a plurality of order transactions, instead of waiting for one transaction to end before another transaction begins. Moreover, the order entry of one user will not be affected by the order entries of other users.

Once logged into the account database system 120, the user may view catalogs of items available for ordering via web pages and choose which items to order, thereby adding the items to a web page shopping cart. The user may set or change the “ship to” address, provide a purchase order number, provide specific shipping instructions, charge the purchase to an account or to a credit card, etc. In step 203, the user's selection of items to be ordered is received by the account database system 120 via the web page. The web page may display items available for ordering, quantities, prices, etc. The user may select one or more of the items, for example, by selecting check boxes on the display via the user interface.

The account database system 120 receives payment information from the user in step 204 for making a payment for the selected items. The payment information may be user account information, for example, or credit card information, e.g., card number, expiration date, etc. In step 205, an order header record is written to a processing server data store, which can be a database on the web server. A batch ID may also be written to the processing server data store in step 205. In step 206, batch detail records are written to the processing server data store for the selected items. A batch detail record may be created for each order of a user.

In step 207, it is determined whether the payment is by credit card. If the payment is by credit card, then in step 208 the payment information is processed. The processing of the payment information may include sending the payment information to an external payment service, e.g., Verisign Payment Services, for payment authorization processing. In step 209, the batch header record is updated with the authorization information for the payment transaction.

In step 210, it is determined whether the payment authorization was successfully processed. If the payment processing was not successful, an error message may be outputted to the user in step 211 to inform the user that the payment could not be processed. The payment file may be an accounting system electronic payment table, for example. In step 212, a record of the order information may be written to a custom database 140 in the account database system 120 of the service provider. The order information may be recorded in a header file and a detail file, which may include, for example, the following information:

Header File

User Reserved Reference—Web Order Reference Number

Document Key Company

Document Number

Document Type

Order Company

Order Number

Order Type

Business Unit

Address Number

Ship To

Order Date

Delivery Instructions

Order Taken By

Vehicle ID

Authorization Number

Reference—Purchase Order Number

Payment Terms

User ID

Program ID

Workstation ID

Date Updated

Time of Day

Mailing Name—Sold To

Address Line 1

Address Line 2

Address Line 3

Address Line 4

Postal Code

City

County

State

Country

Secondary Mailing Name—Ship To

Producer Address Line 1

Producer Address Line 2

Producer Address Line 3

Producer Address Line 4

Second Postal Code

City

Configured Model

State

Country

Variable Return Data—Web User ID

Description—Web User ID Email Address

Detail File

User Reserved Reference—Web Order Reference Number

Document Key Company

Document Number

Document Type

Line Number

Order Company

Order Number

Order Type

Line Number

Ship To

Parent Number

Order Date

2^{nd} Item Number

Line Type

Status Code—Next

Status Code—Last

Quantity

Transaction Originator

User ID

Program ID

Work Station ID

Date Updated

Time of Day

In step 213, it is determined whether the header and detail information of the order transaction have been successfully written to the accounting system. If the information has not been successfully written, a notification, such as an e-mail, may be sent in step 214 to a company personnel that the order was not properly communicated to the accounting system and will need to be completed manually. Also, the checkout page, including the errors, may be displayed to the user.

The writing of the record into the custom database may be detected in step 215. The writing of the record will trigger the execution of an accounting program for posting the order information to the user's account and to records of the service provider in step 216. The accounting program may be a JD Edwards accounting program, for example. The order information is updated to reflect that the order has been placed. Also, an alternate “ship to” address may be written to an accounting program file.

In an exemplary embodiment of the present invention, a DB2 database trigger executes the accounting program, which may perform error checking and data formatting. For example, formatting and error checking of an item number, business unit and customer number may be performed.

In step 217, the accounting program updates a custom transaction table and outputs the updated order information to the user. In step 218, the processing server detects posting of orders completed and updates the processing server data store, i.e., the order header record created in step 205, based on the completed orders. If the payment authorization described above was successfully processed, authorization data received from the external payment service may be written by the processing server to a payment file of the user in step 219. If the information was successfully written to the accounting system as determined in step 213, a message may be outputted to the user in step 220 confirming the order and an order number may be displayed to the user. The message may be sent by e-mail, for example.

In another exemplary embodiment of the present invention, there is a computer-readable medium encoded with a computer program for managing order entry by a user via remote connection to an account database system of a service provider. The term “computer-readable medium” as used herein refers to any medium that participates in providing instructions for execution. Such a medium may take many forms, including but not limited to, non-volatile media, volatile media, and transmission media. Non-volatile media includes, for example, optical or magnetic disks. Volatile media includes, for example, dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave, or any other medium from which a computer can read.

An exemplary embodiment of a computer-readable medium encoded with a computer program for managing order entry by a user via remote connection to an account database system of a service provider is illustrated in FIGS. 2A and 2B, which are described above.

While the invention has been described in connection with various embodiments, it will be understood that the invention is capable of further modifications. This application is intended to cover any variations, uses or adaptation of the invention following, in general, the principles of the invention, and including such departures from the present disclosure as, within the known and customary practice within the art to which the invention pertains.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for managing order entry by a user via remote connection to an account database system of a service provider, comprising the acts of:
receiving order information for an order transaction initiated by the user;
detecting a trigger event in the account database system, indicating that the order transaction has been successfully processed; and
executing an accounting program for posting the order information to an account of the user and to records of the service provider.

2. The method of claim 1, wherein the trigger event triggers a DB2 function.

3. The method of claim 1, wherein the trigger event comprises writing a transaction record to an account transactions file of the service provider.

4. The method of claim 1, further comprising the act of:
receiving payment information corresponding to the order information from the user via the remote connection.

5. The method of claim 4, further comprising the act of:
outputting the payment information to an external payment service for payment authorization.

6. The method of claim 1, wherein the order information is received from a web page.

7. The method of claim 1, further comprising the act of:
displaying updated account information to the user after the accounting program is executed.

8. The method of claim 1, wherein posting the order information comprises recording the order information in a header file and a detail file.

9. The method of claim 1, wherein the remote connection comprises an Internet connection.

10. The method of claim 1, wherein the method is simultaneously performed for a plurality of order transactions.

11. A method for managing order entry by a user via remote connection to an account database system of a service provider, comprising the acts of:
receiving order information from the user for an account of the user via the remote connection;
writing a transaction record to an account transactions file of the service provider, thereby triggering execution of an accounting program for posting the order information to the account of the user and to records of the service provider; and
outputting updated order information to the user, after execution of the accounting program.

12. The method of claim 11, wherein triggering execution of the accounting program comprises triggering a DB2 function.

13. The method of claim 11, wherein the method is simultaneously performed for a plurality of order transactions.

14. The method of claim 10, further comprising the act of:
receiving login information of the user via the remote connection.

15. A computer-readable medium encoded with a program for managing order entry by a user via remote connection to an account database system of a service provider, the program comprising instructions for:
receiving order information for an order transaction initiated by the user;
detecting a trigger event in the account database system, indicating that the order transaction has been successfully processed; and
executing an accounting program for posting the order information to an account of the user and to records of the service provider.

16. The computer-readable medium of claim 15, wherein the trigger event comprises writing a transaction record to an account transactions file of the service provider.

17. The computer-readable medium of claim 15, further comprising instructions for:
receiving payment information from the user corresponding to the order information of the account of the user via the remote connection.

18. The computer-readable medium of claim 15, further comprising instructions for:
outputting the payment information to an external payment service for payment authorization.

19. The computer-readable medium of claim 15, wherein the order information is received from a web page.

20. The computer-readable medium of claim 15, further comprising instructions for:
displaying updated account information to the user after the accounting program is executed.
